(19) United States
(12) Patent Application Publication
(10) Pub. No.: US 2026/0052093 A1
(43) Pub. Date: Feb. 19, 2026

(54) USING UNDERLAY TRANSPORT LINK PROTECTION TO PROTECT POINT TO MULTIPOINT TREES

(71) Applicant: CIENA CORPORATION, Hanover, MD (US)

(72) Inventors: BINDHIA KOMATH, San Jose, CA (US); CHIEN-HUNG HUANG, San Jose, CA (US); NORMAN LIN, San Jose, CA (US); SAMI BOUTROS, San Jose, CA (US); Ramkumar Parameswaran, San Jose, CA (US)

(73) Assignee: CIENA CORPORATION, Hanover, MD (US)

(21) Appl. No.: 18/802,495

(22) Filed: Aug. 13, 2024

(51) Int. Cl. H04L 45/16; H04L 45/28; H04L 45/50

(52) U.S. Cl. CPC H04L 45/16; H04L 45/28; H04L 45/50

(57) ABSTRACT

Aspects of the subject disclosure may include, for example, receiving, at a router forming an ingress router in a point-to-multipoint network, a point-to-multipoint dataflow comprising a plurality of packets, forwarding, to a data network, packets of the point-to-multipoint dataflow for communication to a plurality of point-to-multipoint receivers along respective Label Switched Paths, the plurality of point-to-multipoint receivers associated with one or more egress nodes of the point-to-multipoint network, identifying a network failure between the router and a nexthop router for one Label Switched Path, and routing packets of the point-to-multipoint dataflow according to a preexisting unicast backup Label Switched Path for the one Label Switched Path. Other embodiments are disclosed.

### FIELD OF THE DISCLOSURE

The subject disclosure relates to use of underlay transport link protection to protect point-to-multipoint trees in a data communication network.

### BACKGROUND

Point to multipoint (P2MP) transmission is a type of group communication where data transmission is addressed from a single source computer to a group of destination computers simultaneously. In multicast transmission, information such as a video stream is delivered to a group of nodes. Transmitted data may flow through a network of routers according to a predefined data communication protocol. Datagrams may be routed simultaneously in a single transmission to many recipients. Pre-calculated rerouting solutions ensure that network outages will have minimal impact on data flows through networks.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of packet flow in a network in accordance with various aspects described herein.

FIG. 2 is a block diagram illustrating an exemplary, non-limiting embodiment of a point-to-multipoint (P2MP) data network 200 in accordance with various aspects described herein.

FIG. 3 is a block diagram illustrating an exemplary, non-limiting embodiment of packet flow in a network in accordance with various aspects described herein.

FIG. 4 is a block diagram illustrating an exemplary, non-limiting embodiment of packet flow in a network in accordance with various aspects described herein.

FIG. 5 depicts an illustrative embodiment of a method in accordance with various aspects described herein.

FIG. 6 is a block diagram of an example, non-limiting embodiment of a computing environment in accordance with various aspects described herein.

### DETAILED DESCRIPTION

The subject disclosure describes, among other things, illustrative embodiments for providing backup or protection for a point-to-multipoint data flow or tree in a data network. A preexisting, precalculated backup path or backup tunnel for a unicast transport tunnel is selected and used to provide backup in case of a network failure between the router and a nexthop. This reduces the need to wait for reconvergence of the network following the network failure so that rerouting of the point-to-multipoint tree can be accomplished in milliseconds rather than seconds. Other embodiments are described in the subject disclosure.

One or more aspects of the subject disclosure include a router operative to process a point-to-multipoint data flow. The router may perform operations including receiving a point-to-multipoint dataflow comprising a plurality of packets, forwarding, to a data network, packets of the point-to-multipoint dataflow for communication to a plurality of point-to-multipoint receivers along respective Label Switched Paths, identifying a network failure between the router and a nexthop router for one Label Switched Path, and routing packets of the point-to-multipoint dataflow according to a preexisting unicast backup Label Switched Path for the one Label Switched Path.

One or more aspects of the subject disclosure include receiving, at a router forming an ingress router in a point-to-multipoint network, a point-to-multipoint dataflow comprising a plurality of packets, forwarding, to a data network, packets of the point-to-multipoint dataflow for communication to a plurality of point-to-multipoint receivers along respective Label Switched Paths, the plurality of point-to-multipoint receivers associated with one or more egress nodes of the point-to-multipoint network, identifying a network failure between the router and a nexthop router for one Label Switched Path, and routing packets of the point-to-multipoint dataflow according to a preexisting unicast backup Label Switched Path for the one Label Switched Path.

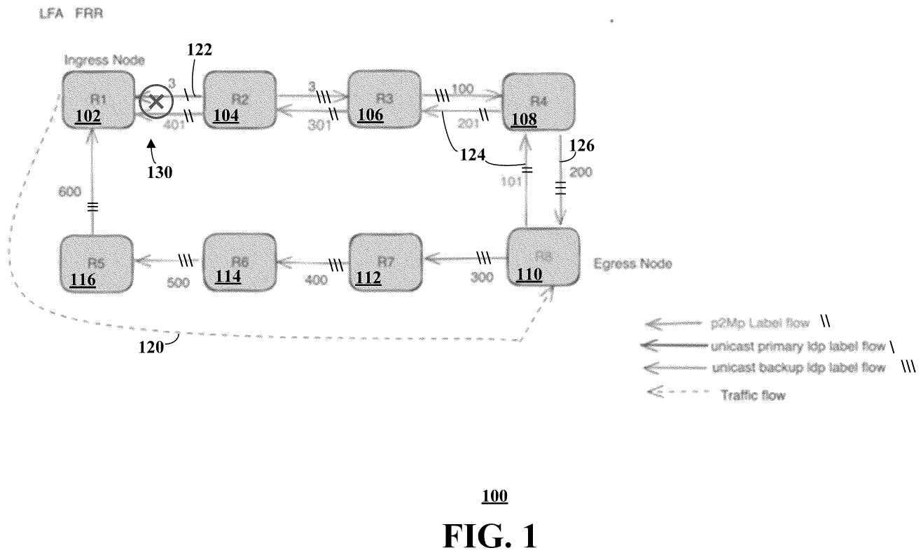

FIG. 1 is a block diagram illustrating an exemplary, non-limiting embodiment of a data network 100 in accordance with various aspects described herein. The data network 100 includes switching devices including router 102, router 104, router 106, router 108, router 110, router 112, router 114, and router 116. The number and arrangement of the routers of the data network 100 is exemplary only. In general, each router receives data, such as at router 102, labeled ingress node in FIG. 1, and conveys the data to the next router and toward a destination. In the example of FIG. 1, the data is conveyed to router 110 labelled egress node.

In embodiments, the routers including router 102, the ingress node, and router 110, the egress node, may be established in any suitable form. In some embodiments, the routers comprise physical components including data processing systems, memory, communication interfaces and control modules located in a suitable physical location. In other embodiments, one or more routers may be instantiated virtually, as virtual machines with suitable functionality to perform the operations described herein and located at a suitable network location. The data network 100 may include any suitable combination of physical routers and virtual routers. Moreover, any suitable data processing system may be enabled to perform the function of the routers described herein.

Data may be organized as packets having a predetermined composition, generally including a header and payload. The header includes addressing information which defines a source and a destination for the packet. The addressing information of the header is used by each router to route the packet to the next router.

In the exemplary embodiment, the data network 100 employs Multiprotocol Label Switching (MPLS). MPLS is a routing technique that directs data from one node such as a router to the next node based on labels affixed to the packet rather than network addresses. Whereas a network address identifies an endpoint, the labels identify established paths between endpoints through the data network 100.

In an MPLS network such as data network 100, labels are assigned to data packets. Packet-forwarding is performed based on the contents of the label, with no need to examine contents of the packet payload. Thus, an MPLS network such as data network 100 can carry different types of traffic including internet protocol (IP) packets. The header may include one or more labels, referred to as a label stack. The MPLS packets are switched among routers of the data network 100 according to the information in the label rather than a lookup in an IP routing table, for example.

Each of the routers of the data network 100 generally includes a data processing system including one or more processors and memory for storing data and instructions. Each of the routers forwards data packets between two or more computer networks, not shown in FIG. 1 but in data communication with data network 100. When a packet is received at a router, the router reads the MPLS label and forwards the packet to the next router identified by the MPLS label.

The router 102 (the ingress node) and the router 110 (the egress node) form label edge routers. They operate at the edges of the data network 100 and form entry and exit points for the data network 100. When a packet is received at the label edge router, the label edge router pushes an MPLS label onto the incoming packet. As the packet exits the data network 100, the label edge router pops the MPLS label off the packet.

Routers interior to the data network 100, such as router 104, router 106, router 108, router 112, router 114, and router 116, generally perform routing only based on the MPLS label and may be termed label switch routers. The label switch routers operate to switch the labels used to route packets. When a label switch router receives a packet, it reads the label included in the packet header to determine the next hop on the label-switched path. The router may use a lookup table or other resource to determine the corresponding label for the next hop or next router toward the destination of the packet. The label switch router then removes the old label from the header of the packet and replaces the old label with the label for the next hop. The packet is then forwarded accordingly.

Labels are distributed among the routers of the data network 100 using label distribution protocol (LDP). Routers in an MPLS network such as the data network 100 regularly exchange label and reachability information with each other using standardized procedures in order to build a complete picture of the network so that they can then use that information to forward the packets. Label distribution protocol can also be used to distribute inner labels, corresponding to a virtual private network (VPN), for example, and outer labels, corresponding to a path label. Two routers in the data network 100 establish a session and are called LDP peers. The exchange of information between LDP peers is bi-directional. LDP is used to build and maintain label-switched path (LSP) databases that are used to forward traffic through MPLS networks.

When an unlabeled packet enters the ingress router, such as router 102, the router inserts one or more labels in the packet's newly created MPLS header. The packet is then passed on to the next hop router. When a labeled packet is received by an MPLS router, such as router 104 or other interior routers in FIG. 1, the topmost label is examined. Based on the contents of the label, the MPLS router performs a swap, push or pop operation on the packet's label stack. In a swap operation, the label is swapped with a new label, and the packet is forwarded along the path associated with the new label. In a push operation, a new label is pushed on top of the existing label, effectively encapsulating the packet in another layer of MPLS. This allows hierarchical routing of MPLS packets. In a pop operation, the label is removed from the packet, which may reveal an inner label below. This process may be called decapsulation. If the popped label was the last on the label stack, the packet leaves the data network 100. This can be done by the egress router, such as router 110.

As noted, router 102 is labeled ingress node and router 110 is labeled egress router. An ingress router is a label switch router that is a starting point or source for a given label switched path. The roles of ingress router and egress router are specific to the label-switched path. Generally, an MPLS label is attached to a packet at the ingress router and removed at the egress router, and label swapping is performed on the intermediate, interior routers. However, in some instances, the ingress router or another router may push a label on the label stack of an already existing MPLS packet.

The data network 100 may enable unicast transmission, point to multipoint transmission and multicast transmission. Unicast transmission is a one-to-one transmission from one node in the network to another node. There is one sender and one receiver, each identified by a network address.

Point to multipoint (P2MP) transmission is a type of group communication where data transmission is directed from a single source computer to a group of destination computers simultaneously. In the data network 100, a single node provides P2MP data to the source node, router 102. Receivers of the P2MP data are in communication with the egress node, router 110. In some examples, ingress replication may be introduced to forward multicast traffic to relevant recipients in the network or beyond the network. A data stream such as a video file may be received at the network at an ingress node, communicated among routers of the network to two or more egress nodes and conveyed to the recipients.

In multicast transmission, information such as a video stream is delivered from a source node to a group of destination nodes. Transmitted data may flow through a network of routers such as the data network 100 according to a predefined data communication protocol such as MPLS. Packets may be routed simultaneously in a single transmission to many recipients. Pre-calculated rerouting solutions ensure that network outages will have minimal impact on data flows through networks.

Networks may employ link protection to safeguard the network from failure of a device such as a router or a connection between devices such as a fiber or cable. Network failures can delay traffic or completely block transmission. In a link protection scheme, the end nodes of the failed link initiate the protection. These nodes detect the fault and initiate the protection mechanism to reroute affected traffic from the failed link to a predetermined backup path.

In MPLS local protection, each label switched path passing through the data network 100 is protected by a backup path which originates at the node immediately upstream in the data network 100. Local protection provides rapid recovery in the event of a link failure because the decision of recovery is locally made. For example, the recovery time may be on the order of 50 milliseconds (ms). Each link used by a label switched path is provided protection by pre-established backup paths. The backup paths are established before the failure. When link protection is considered, label switched paths can be categorized as primary (working), secondary (backup) and tertiary (path of last resort).

In FIG. 1, data traffic flow 120 is indicated by an arrow 120 from the ingress node, router 102, to the egress node, router 110. A unicast transport label flow 122 is indicated by arrows with a single hash mark (\). A p2MP label flow 124 is indicated by arrows with a double hash mark (\\). A unicast backup label distribution protocol (LDP) label flow 126 is indicated by arrows with a triple hash mark (\\\).

The unicast transport label flow 122 illustrates the flow of labels along a label switched path. The labels of the unicast transport label flow 122 indicate the labels learned by the transport network for, for example label distribution protocol and segment routing. Typically, the ingress router such as router 102 receives an IP packet without a label, pushes a label learned from the next-hop router, and forwards the packet to the next-hop router. In FIG. 1, the ingress router 102 receives an IP packet and should push a label learned from router 104. However, router 102 learns a label 3 (implicit NULL) from router 104. Hence, router 102 will not push the label to the packet and forward the packet without a label to router 104. Note that the label 3 is called implicit NULL, which should never be pushed in a packet's label stack.

In operation, during primary data flow through the data network 100, router 102 receives a packet having a label. The router 102 uses the existing label as an index to determine the next hop, in this case to router 104. The router 102 removes the old label and inserts in the packet a label having a value 3, corresponding to the link to the next hop router 102. The packet is then transmitted on by the router 102.

Similarly, router 102 has learned a backup label having a value of 600 for router 104, indicated as R2, from router 116, indicated as R5 in the drawing figure. The backup label is an aspect of a fast reroute option in some networks. When a link or a router in a network such as data network 100 fails, a distributed routing algorithm computes new routes that bypass the failure. The time taken for computing a new route is called routing transition. Until the transition is complete and all routers are converged on a common view of the network, the connectivity between the source and destination pairs is interrupted. However, the fast reroute (FRR) feature can reduce the routing transition time to less than 50 ms using a precomputed alternate next hop. When a router is notified of a link failure, the router immediately switches over to the repair path to reduce traffic loss. The backup label flow 126 originates at the egress node, router 110, and propagates toward the ingress node, router 102.

In operation for a unicast data flow, if a link failure occurs at a link such as link 130, between router 102 and router 104, when the router 102 becomes aware of the link failure, rather than applying the primary label having the value 3 to a received packet will instead apply the backup label having the value 600 to the packet. The packet will then be forwarded to router 116. Router 116 will swap the label on the packet and add a backup label having a value 500 to the packet and the packet will be passed to router 114. Similarly, router 114 will swap the label on the packet and add a backup label having a value 400. The packet will be routed to router 112. This backup label switching process continues until the packet gets to router 104. The router 104 is aware of the failed link 130 and uses the unicast transport label flow 122 to forward the packet to egress node, router 110. This data flow, from router 104 to router 110, will continue until convergence. Convergence occurs when all routers share routing information with all routers in the data network 100. In the converged network, all routers are aware of the network topology and the optimal route to send a packet.

The illustrated fast reroute process is effective at rapidly restoring service and data flow in the data network 100. Some embodiments may implement loop-free alternate (LFA), remote loop-free alternate (RLFA) or topology independent loop free alternate (TILFA) backup and protection in the data network 100.

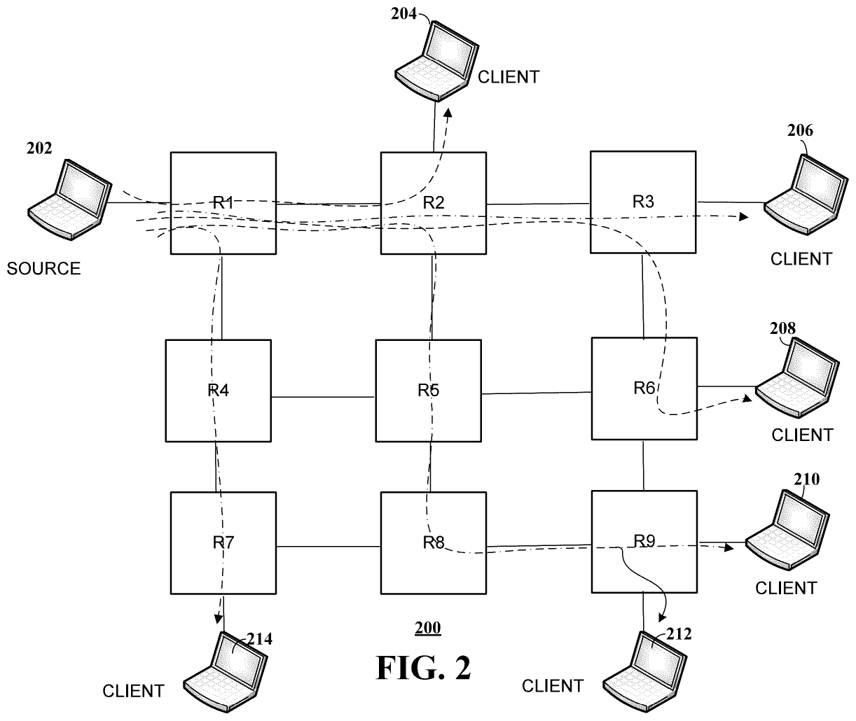

FIG. 2 is a block diagram illustrating an exemplary, non-limiting embodiment of a point-to-multipoint (p2MP) data network 200 in accordance with various aspects described herein. The p2MP data network 200 includes a plurality of nodes or routers labelled R1 through R9. The number and configuration of the routers in the p2MP data network is exemplary only. A source node, root 202, serves as the source of the p2MP data flow in the p2MP data network 200. Multiple receivers, in the form of leaf node 204, leaf node 206, leaf node 208, leaf node 210, leaf node 212, and leaf node 214, receive the p2MP data flow through the p2MP data network 200. There is a single ingress node, router R1, and multiple egress nodes including router R2, router R3, router R6, router R9 and router R7. Two leaf nodes leaf node 210 and leaf node 212, access the P2MP data flow through the same egress node, router R9.

To establish a point-to-multipoint label switch path (LSP), each leaf node initiates a tree setup. The leaf node sends a label distribution protocol (LDP) map message to its upstream hop toward the root node, root 202. Each node in the tree receives the LDP message and sends another LDP map message to its upstream hop toward the root 202. Each LDP map message includes a label and the label is used for forwarding packets from the root 202 to respective leaves.

Referring again to FIG. 1, in the case of a point-to-multipoint (p2MP) data flow such as p2MP data flow 124, similar to the p2MP data network 200 of FIG. 2, there are multiple data streams flowing in the data network 100 and there may be multiple egress nodes along with the illustrated egress node, router 110. The source node, router 102 in the example of FIG. 1, makes multiple replicas of each packet and routes the packets to the multiple egress nodes. The p2MP data flows may be visualized as a tree, where the source node corresponds to a root of the tree and the egress nodes and p2MP receivers correspond to leaves of the tree.

FIG. 1 illustrates propagation of multicast label distribution protocol (MLDP) labels in a p2MP network. The MLDP labels are used for establishing label switched paths (LSPs) for routing primary p2MP traffic in the data network 100. The p2MP label flow 124 is shown with arrows with two hash marks (\\). The p2MP labels are propagated upstream from the egress node, router 110. Thus, router 110 has a p2MP label having a value 101. Router 108 has a p2MP label having a value 201. Router 106 has a p2MP label having a value 301. Router 104 has a p2MP label having a value of 401. For multicast traffic originating from the source node, router 102, and destined for egress node, router 110, will use these labels. Router 102 will put label having a value 401 on packets intended for router 110. This label will get swapped by label having a value 301 at router 104. This router will get swapped by label having a value 201 by router 106, and so forth. The packet will eventually reach the egress node, router 110, with value 101. Router 110 will then forward the packet to any leaf nodes in communication with the router 110 for the p2MP data flow.

In the case of a failure in a p2MP environment, one or more p2MP data flows may be affected by the failure. Some other p2MP data flows may be unaffected by the failure. The receivers or leaf nodes who are affected will experience an interruption in the data flow and may experience lost packets.

Conventionally in a p2MP environment, a failure in a link or node requires waiting for reconvergence of the network. One or more data flows will stop, and packets may be lost to one or more p2MP receivers. There is no fast reroute available for p2MP as in the unicast example. All traffic will stop at router 102. A new label flow will occur, starting at the egress node, router 110, extending to router 112, router 114, router 116 and router 102. Then, traffic will resume in the primary direction, from router 102 to router 116, router 114, router 112 and router 110, the egress node. This reconvergence can require a substantial amount of time, such as on the order of a few seconds, to accommodate the failure in the network when using P2MP technology while routing information is shared among the routers.

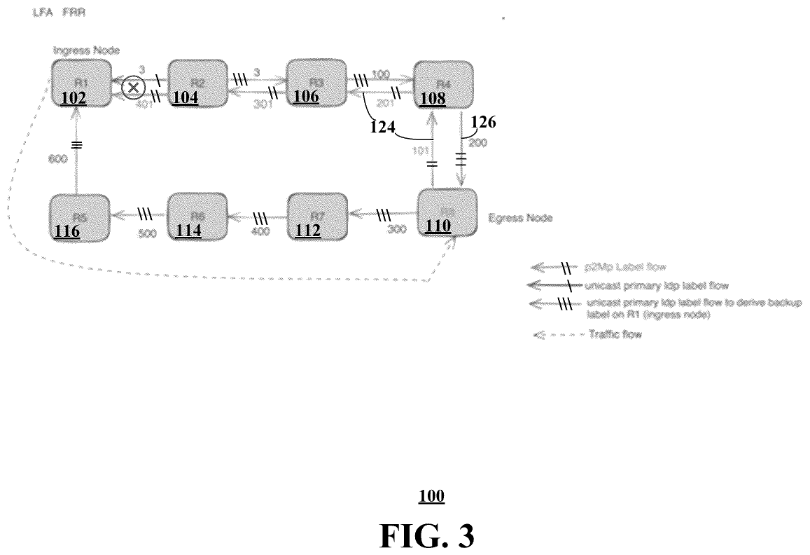

FIG. 3 is a block diagram illustrating an exemplary, non-limiting embodiment of packet flow in the data network 100 in accordance with various aspects described herein. In particular, FIG. 3 illustrates loop-free alternate (LFA) backup in a data network. FIG. 3 illustrates label flow of unicast primary label distribution protocol (LDP) labels to derive back labels for router 102, indicated as R1. A unicast backup label distribution protocol (LDP) label flow 126 is indicated by arrows with a triple hash mark (\\\). A p2MP label flow 124 is indicated by arrows with a double hash mark (\\).

The backup label flow 126 corresponds to a backup label switched path (LSP) to provide backup or protection in the event of a failure (indicated by the X in the drawing figure) in the link between router 102 and router 104. Generally, each router in the data network 100 has a backup LSP computed for the router. Router 102, indicated as R1, has a protected LSP that runs from the ingress noted at router 102 to the egress node at router 110, indicated as R8.

For each router in the data network 100, a backup label is propagated through the data network 100 to a router upstream of the router. The backup label defines a backup tunnel to be used in case of a network failure. In the example of FIG. 3, router 104, indicated as R2, generates a backup label having a value of 3. In this example, the backup label value corresponds to the primary unicast label value of 3 in the unicast label propagated to the router 102 for handling unicast traffic from router 102 to router 104. The backup label having a value of 3 is propagated to the nexthop, router 106. Router 106 in turn propagates a backup label having a value of 100 to router 108. Router 108 in turn propagates a backup label having a value 200 to router 110. Router 110 in turn propagates a backup label having a value 300 to router 112. Router 112 in turn propagates a backup label having a value 400 to router 114. Router 114 in turn propagates a backup label having a value 500 to router 116. Finally, router 116 propagates a backup label having a value 600 to router 102. The set of backup labels define a backup LSP for the router 104, indicated as R2.

In the example of FIG. 3, p2MP or multicast traffic is received at ingress node, router 102, intended for the egress node, router 110. This corresponds to one multicast receiver intended as a recipient for the p2MP data flow including received p2MP packets. Upon receipt of a p2MP packet for this p2MP data flow, the router 102 pushes on to the packet a label corresponding to the nexthop, router 104. As indicated in the figure, router 104 has a label having a value of 401. Router 104, in turn, receives the packet, pops the label with value 401, and pushes a label corresponding to the nexthop, router 106, or a label having a value 301. Similarly, router 106 switches the label to a label having a value 201, corresponding to router 108, and router 108 switches the label to a label having a value 101, corresponding to router 110. Router 110 pops the p2MP label and forwards the packet out of the data network 100 to the intended multicast receiver. This corresponds to normal, error free operation in the data network 100.

In the event of the failure in the link between router 102 and router 104, when a packet is received by router 102 intended for the egress node router 110, the router 102 will push onto the packet the normal p2MP label for router 104, the intended destination for the packet from router 102. This normal p2MP label has a value 401 corresponding to router 104, indicated at R2. In addition, router 102 will push the backup label on top of the normal p2MP label. In this case the backup label is the unicast backup label for the router 102. The backup label has a value 600 as indicated in FIG. 3 and corresponds to router 116. Router 102 will forward the packet according to the backup label to router 116.

Router 116 will receive the packet from router 102 and will swap the label with value 600 with a label having a value 500, corresponding to router 114. Similarly, router 114 will swap the label with value 500 with a label having value 400, corresponding to router 112; router 112 will swap the label with value 400 with a label having value 300, corresponding to router 110. The process will continue for the packet, with the backup label being swapped with the backup label for the next hop leading back to router 104. At router 104, the backup transport label will be popped and replaced with the MLDP label having a value 401. This is the value that the packet received from router 102 had the link between router 102 and router 104 been in place. Operation then proceeds normally to route the packet from router 104 to router 106 and so on, to the egress node at router 110.

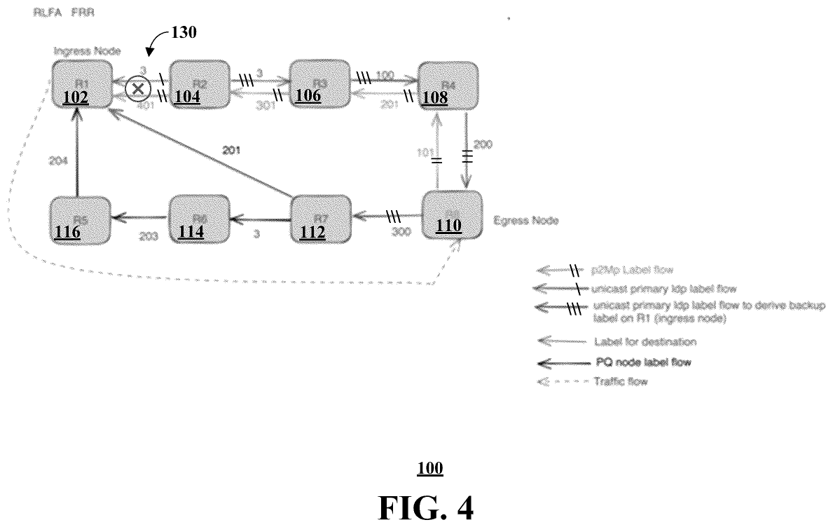

FIG. 4 is a block diagram illustrating an exemplary, non-limiting embodiment of packet flow in the data network 100 in accordance with various aspects described herein. In particular, FIG. 4 illustrates remote loop-free alternate (RLFA) backup in a data network.

RLFA backup provides an alternative method for protecting a link in a network. RLFA identifies a node to which traffic can be forwarded from the source node without traversing a failed link. RLFA then forms an R-LFA tunnel to that node. In FIG. 4 as in FIG. 1 and FIG. 3, a link 130 between router 102 and router 104 fails. Through the conventional RLFA process, the router 112, indicated as R7 in the drawing figure, is identified as the PQ node or PQ router. The PQ router, router 112, propagates its label as the PQ node to the source node, router 102. That is, in the example, a label having the value of 3 is forwarded by router 112 to router 114. Router 114, in turn, forwards a label having a value 203 to router 116. Router 116, in turn, forwards a label having a value 204 to the source node, router 102. Router 102 then builds a repair tunnel to the PQ router, router 112, reachable using a label having a value 201.

For rerouting traffic around the network failure at link 130, the source router, router 102, pushes labels on the label stack of a packet. One label has a value 201, directing the packet to the PQ router, router 112. A second label has a value 300, directing the packet to the router 104 instead of the egress node, router 110. Note that in the example here is the unicast backup path using the backup label to reach router 104. The unicast packet is terminated in router 104, and then continues forwarding the packet using the multicast p2mp label from router 104 to the egress node, router 110.

The link protection features and node protection features such as FRR, LFA, R-LFA an TI-LFA, are established for a unicast transport network. These node protection features provide excellent and rapid response in the event of a network failure. Based on the regular unicast LFA, R-LFA and TI-LFA calculation, the ingress router R1 can have backups for all the routers in the network, i.e., R2 to R8, in the topology of the data network 100. In order to reach the ultimate leaf R8 at the egress node, router 110, packets may have to traverse through transit multiple nodes such as the routers indicated as R5, R6, etc. The conventional unicast protection features protect against immediate link failure on the nexthop router. A network failure can occur anywhere in the network, as data packets are replicated on the p2mp tree. Each ingress (root or transit) node replicating the p2MP dataflow may get the protection for its immediate nexthop routers. The protection features set up for the unicast network are available for use in a p2MP arrangement, as well.

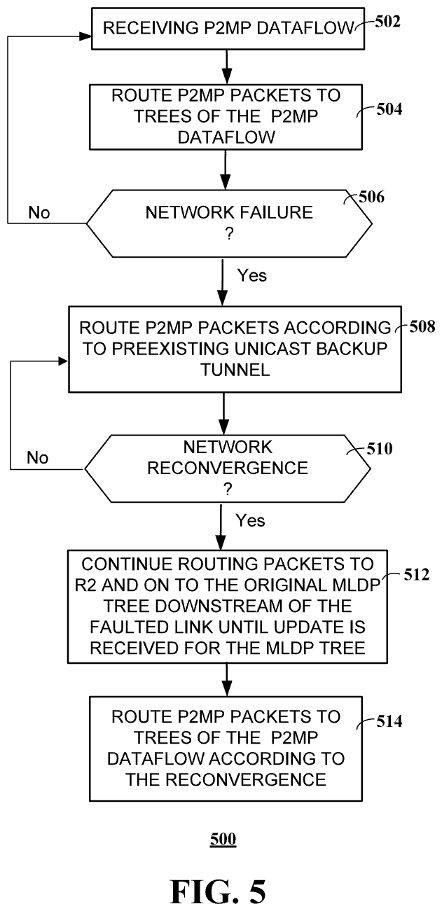

FIG. 5 depicts an illustrative embodiment of a method 500 in accordance with various aspects described herein. The method 500 may be performed, for example, at a router such as router 102 of data network 100 shown in FIG. 1. The method may be performed at a physical router or at a virtual router instantiated at a selected network location to operate in conjunction with the data network 100 and perform the functions described herein. In some embodiments, the method 500 may be performed at an ingress node such as router 102, indicated as R1 in FIG. 1.

The network may be configured for unicast communication in which data is transmitted from a single source to a single receiver. Routers of the network may propagate Label Distribution Protocol (LDP) labels for addressing and communication among the routers of the network. Moreover, the routers of the network may precompute protection paths in the network. In the event of a network failure, a unicast protection path may be retrieved and used to reroute unicast traffic in the network until the network failure is corrected. Some embodiments implement Fast Reroute (FRR) link protection. Such protection paths may include loop-free alternate protection, remote loop-free alternate protection (RLFA), and topology independent loop-free alternate protection (TI-LFA). The protection paths may be termed backup Label Switched Path (backup LSPs). A protection path forms a tunnel from a router upstream of the network failure to a router downstream of the network failure. Before operation, the network reaches convergence and all routers have access to all required labels and protection paths.

The method 500 may be initiated in any suitable manner. For example, a point-to-multipoint p2MP network may be established in a network using Multicast Label Distribution Protocol (MLDP). The unicast transport network, including link protection information, forms an underlay to the p2MP network. One or more label switched paths (LSPs) or trees may be established in the network for distribution and routing of dataflows such as video files or audio files, an exemplified in FIG. 2. The LSPs or trees may be established between a root or ingress node and two or more leaves or egress nodes. For routing, MLDP labels may be propagated through the routers of the network from the leaves to the root. The MLDP labels may rely on or incorporate the LDP labels of the underlay unicast transport network.

At step 502, a dataflow may be received at the root. The dataflow may be any p2MP data or multicast data requested by receivers in communication with the leaves of the p2MP network. The dataflow may be organized as a stream of packets, each packet including a header and a payload. The header includes addressing information including a label stack. A router may push or pop a label on the label stack to control routing in the network such as to a nexthop router. At step 504, the received packets may be replicated and routed through the network to the respective leaves according to the LSPs for reception at one or more receivers associated with the LSPs. Routing the packets may include, for example, pushing a p2MP label associated with the nexthop router onto a label stack of the packet of the dataflow to forward the packet to the nexthop router. The label includes necessary addressing information.

At step 506, the method 500 includes determining if a network failure has occurred. Any suitable network failure may be detected, such as a link failure of a communication link between routers or switches or a device failure. The network failure corresponds to some interruption of communication at some point in the network. If no network failure occurs and is detected, control returns to step 502 to continue processing the incoming p2MP dataflow. This corresponds to normal operation.

If, however, at step 506, a network failure occurs, the affected router and the network will respond to detour data around the network failure. In accordance with various aspects describe herein, existing unicast FRR technologies are used to do faster switchover to a backup configuration and reroute traffic around the network failure. Unicast FRR protection may require 50 ms or less to implement. In contrast, conventional p2MP networks respond to a network failure by reconverging the network to account for the failure, which can take several seconds. During those several seconds, one or more receivers of the p2MP dataflow through the network receive no data. The packets may simply be lost.

Accordingly, at step 508, the p2MP packets distributed by a router affected by the network failure are routed according to the preexisting, precomputed unicast backup tunnel or backup LSP. As noted, the link protection scheme for the unicast transport network defines FRR tunnels or backup tunnels for each link in the network or each router in the network. The unicast link protection information is available for the p2MP network to use.

Accordingly, in response to identifying the network failure, the router may push a backup label associated with the preexisting unicast backup Label Switched Path onto the label stack of received packets. The packets may then be forwarded according to the backup label. The backup label operates to enable forwarding the received packet to the nexthop router over the protection path to the nexthop router. The nexthop router, then, is responsive to receiving the p2MP packets for communication to designated p2MP receivers along the MDLP LSPs. For example, the nexthop router may respond to receiving the p2MP packets by popping the backup label from the label stack of the packets and by forwarding the p2MP packets according to a p2MP label associated with the p2MP receivers along Label Switched Paths in the network. The unicast FRR backup labels are used to reroute the p2MP traffic around the network failure.

This rerouting of point-to-multipoint traffic may continue until the network has reconverged. Reconvergence corresponds to propagating MDLP labels to all routers to accommodate the network failure. At step 510, the method 500 includes determining if the network has reconverged. If the network has not reconverged, operation continues to step 508 to continue routing data according to the unicast backup LSP. If the network has reconverged, the routers of the network may receive an update to a multicast Label Distribution Protocol tree for routing the packets in the network. For example, the update may be based on the reconvergence of the data network. Subsequently, the routers of the network begin forwarding p2MP packets to the point-to-multipoint receivers according to the update.

In some embodiments, when routing protocols converge following resolution of the network failure, the MLDP directly connected nexthop router may no longer be directly connected to a particular router. For example, in accordance with Interior Gateway Protocol (IGP), the protocol may run new convergence calculations for the router upstream of the network failure and derive new routes. The existing unicast backup is deleted and new unicast primary routes are installed in the hardware. However, this now-disconnected router is reachable via another nexthop router.

In such a case, at step 512, the router may operate to continue routing packets to the now-disconnected nexthop router and on to the new unicast primary path. This may be done, for example, by adding a unicast transport label to a packet label stack of subsequently received packets. For example, a router (corresponding, for example to router 102, indicated as R1, in FIG. 1) may be modified to operate so that the mLDP packet will continue to be routed to router 104, indicated as R2, by explicitly adding a transport label for R2, router 104, on top of the mLDP tree transport label. This way, the packet will be routed to R2 first and then will continue downstream over the original mLDP tree. The algorithm will continue to do this until a modify/delete/add update is seen for the original mLDP tree's Incoming Label Map (ILM) or Forwarding Table Next (FTN). The unicast transport label is associated with the now-disconnected nexthop router. In the label stack, the bottom label will be the MLDP label and the top label will be from this other nexthop router to reach the MLDP directly connected nexthop router. Eventually, MLDP will delete this immediate nexthop from its replication paths, but until this happens, the use of this label stack prevents dropping of any packets. This operates to benefit from the unicast transport tunnels to reach MLDP immediate nexthop router in post convergence after an immediate link failure, before MLDP converges and remove this immediate nexthop from its replication paths.

At step 514, following reconvergence of the MLDP network, the method 500 includes continued routing of p2MP packets of the point-to-multipoint dataflow. Routing resumes to the appropriate egress nodes and on to the p2MP receivers.

While for purposes of simplicity of explanation, the respective processes are shown and described as a series of blocks in FIG. 5 it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

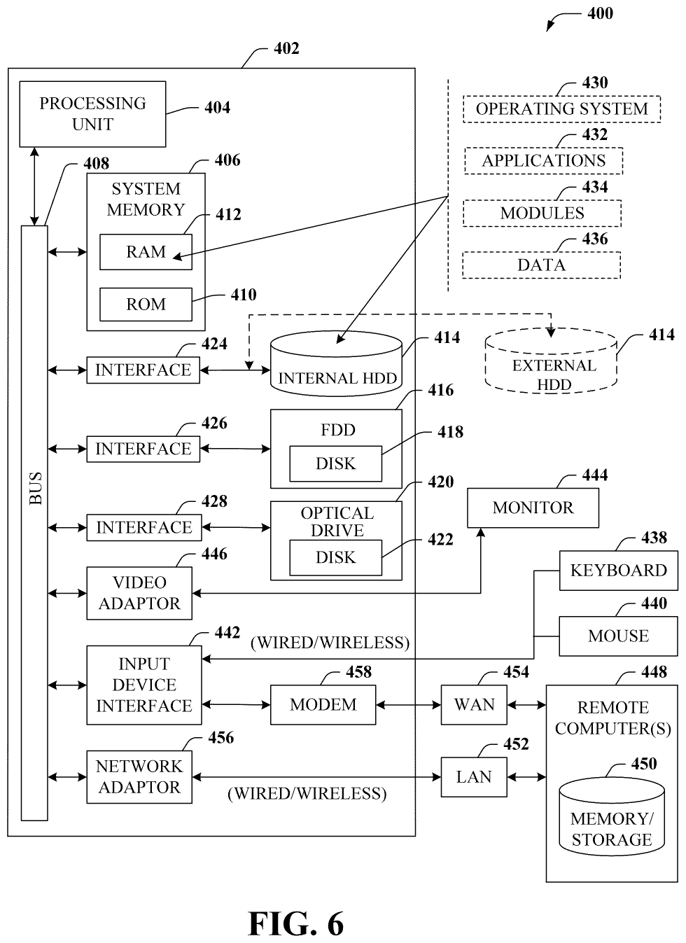

Turning now to FIG. 6, there is illustrated a block diagram of a computing environment in accordance with various aspects described herein. In order to provide additional context for various embodiments of the embodiments described herein, FIG. 6 and the following discussion are intended to provide a brief, general description of a suitable computing environment 400 in which the various embodiments of the subject disclosure can be implemented. For example, computing environment 400 can facilitate in whole or in part operation of a physical router or virtual router using unicast tunnel protection for directly connected MLDP nexthop routers by recursing MLDP replication paths via the protected unicast transport tunnels to the MLDP nexthop routers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 6, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A router, comprising:
a processing system including a processor; and
a memory that stores executable instructions that, when executed by the processing system, facilitate performance of operations, the operations comprising:
receiving a point-to-multipoint dataflow comprising a plurality of packets;
forwarding, to a data network, packets of the point-to-multipoint dataflow for communication to a plurality of point-to-multipoint receivers along respective Label Switched Paths;
identifying a network failure between the router and a nexthop router for one Label Switched Path; and
routing packets of the point-to-multipoint dataflow according to a preexisting unicast backup Label Switched Path for the one Label Switched Path.

2. The router of claim 1, wherein the operations further comprise:
pushing a point-to-multipoint label associated with the nexthop router onto a label stack of a received packet of the point-to-multipoint dataflow to forward the received packet of the point-to-multipoint dataflow; and
responsive to the identifying the network failure, pushing a backup label associated with the preexisting unicast backup Label Switched Path onto the label stack of the received packet.

3. The router of claim 2, wherein the operations further comprise:
responsive to the identifying the network failure, pushing a backup label associated with the preexisting unicast backup Label Switched Path onto a label stack of the received packet, the preexisting unicast backup Label Switched Path forming a protection path to the nexthop router for use during the network failure; and
forwarding the received packet according to the backup label.

4. The router of claim 3, wherein the pushing the backup label onto the label stack of the received packet comprises:
pushing a backup label operative to forward the received packet to the nexthop router over the protection path to the nexthop router,
wherein the nexthop router is responsive to receiving the packets of the point-to-multipoint dataflow, including the received packet, for communication to designated point-to-multipoint receivers along the respective Label Switched Paths.

5. The router of claim 4, wherein the pushing the backup label onto the label stack of the received packet comprises:
pushing a backup label operative to forward the received packet to the nexthop router over the protection path to the nexthop router,
wherein the nexthop router is responsive to receiving the packets of the point-to-multipoint dataflow to pop the backup label from a label stack of the packets of the point-to-multipoint dataflow and to forward the packets of the point-to-multipoint dataflow according to a point-to-multipoint label associated with the designated point-to-multipoint receivers along the respective Label Switched Paths.

6. The router of claim 3, wherein the operations further comprise:
receiving additional packets of the of the point-to-multipoint dataflow; and
forwarding the additional packets according to the backup label until the data network has reconverged following the network failure.

7. The router of claim 1, wherein the operations further comprise:
determining that the data network has reconverged following the network failure;
receiving new unicast primary routes based on a reconvergence of the data network;
receiving subsequent packets of the point-to-multipoint dataflow; and
adding a unicast transport label to a packet label stack of the subsequent packets, wherein the unicast transport label is associated with the nexthop router.

8. The router of claim 7, wherein the operations further comprise:
receiving an update to a multicast Label Distribution Protocol tree for routing the plurality of packets in the data network, the update based the reconvergence of the data network; and
subsequently, forwarding received packets to the point-to-multipoint receivers according to the update.

9. The router of claim 1, wherein the operations further comprise:
identifying the preexisting unicast backup Label Switched Path for the one Label Switched Path, wherein the preexisting unicast backup Label Switched Path is associated with a directly-connected neighbor router that provides a loop free path with respect to the nexthop router.

10. The router of claim 1, wherein the operations further comprise:
identifying a remote loop free alternate backup path; and
routing packets of the point-to-multipoint dataflow according to the remote loop free alternate backup path.

11. A non-transitory machine-readable medium, comprising executable instructions that, when executed by a processing system including a processor, facilitate performance of operations, the operations comprising:
receiving, at a router forming an ingress router in a point-to-multipoint network, a point-to-multipoint dataflow comprising a plurality of packets;
forwarding, to a data network, packets of the point-to-multipoint dataflow for communication to a plurality of point-to-multipoint receivers along respective Label Switched Paths, the plurality of point-to-multipoint receivers associated with one or more egress nodes of the point-to-multipoint network;
identifying a network failure between the router and a nexthop router for one Label Switched Path; and
routing packets of the point-to-multipoint dataflow according to a preexisting unicast backup Label Switched Path for the one Label Switched Path.

12. The non-transitory machine-readable medium of claim 11, wherein the operations further comprise:
pushing a point-to-multipoint label associated with the nexthop router onto a label stack of a received packet of the point-to-multipoint dataflow to forward the received packet of the point-to-multipoint dataflow; and
responsive to the identifying the network failure, pushing a backup label associated with the preexisting unicast backup Label Switched Path onto the label stack of the received packet.

13. The non-transitory machine-readable medium of claim 12, wherein the operations further comprise:
responsive to the identifying the network failure, pushing a backup label associated with the preexisting unicast backup Label Switched Path onto a label stack of the received packet, the preexisting unicast backup Label Switched Path forming a protection path to the nexthop router for use during the network failure; and
forwarding the received packet according to the backup label.

14. The non-transitory machine-readable medium of claim 13, wherein the pushing the backup label onto the label stack of the received packet comprises:
pushing a backup label operative to forward the received packet to the nexthop router over the protection path to the nexthop router,
wherein the nexthop router is responsive to receiving the packets of the point-to-multipoint dataflow, including the received packet, for communication to designated point-to-multipoint receivers along the respective Label Switched Paths.

15. The non-transitory machine-readable medium of claim 14, wherein the pushing the backup label onto the label stack of the received packet comprises:
pushing a backup label operative to forward the received packet to the nexthop router over the protection path to the nexthop router,
wherein the nexthop router responsive to receiving the packets of the point-to-multipoint dataflow to pop the backup label from a label stack of the packets of the point-to-multipoint dataflow and to forward the packets of the point-to-multipoint dataflow according to a point-to-multipoint label associated with the designated point-to-multipoint receivers along the respective Label Switched Paths.

16. The non-transitory machine-readable medium of claim 13, wherein the operations further comprise:
receiving additional packets of the of the point-to-multipoint dataflow; and
forwarding the additional packets according to the backup label until the data network has reconverged following the network failure.

17. The non-transitory machine-readable medium of claim 11, wherein the operations further comprise:
determining that the data network has reconverged following the network failure;
receiving new unicast primary routes based on a reconvergence of the data network;
receiving subsequent packets of the point-to-multipoint dataflow; and
adding a unicast transport label to a packet label stack of the subsequent packets, wherein the unicast transport label is associated with the nexthop router.

18. The non-transitory machine-readable medium of claim 17, wherein the operations further comprise:
receiving an update to a multicast Label Distribution Protocol tree for routing the plurality of packets in the data network, the update based the reconvergence of the data network; and
subsequently, forwarding received packets to the point-to-multipoint receivers according to the update.

19. The non-transitory machine-readable medium of claim 11, wherein the operations further comprise:
identifying the preexisting unicast backup Label Switched Path for the one Label Switched Path, wherein the preexisting unicast backup Label Switched Path is associated with a directly-connected neighbor router that provides a loop free path with respect to the nexthop router.

20. The non-transitory machine-readable medium of claim 11, wherein the operations further comprise:
identifying a remote loop free alternate backup path; and
routing packets of the point-to-multipoint dataflow according to the remote loop free alternate backup path.
